(19) United States
(12) Patent Application Publication
(10) Pub. No.: US 2017/0175707 A1
(43) Pub. Date: Jun. 22, 2017

(54) WIND DRIVEN ELECTRICITY GENERATOR HAVING A TOWER WITH NO NACELLE OR BLADES

(71) Applicants: James Randall BECKERS, Rockville, MD (US); William Harbin DUKE, Atlanta, GA (US)

(72) Inventors: James Randall BECKERS, Rockville, MD (US); William Harbin DUKE, Atlanta, GA (US)

(21) Appl. No.: 14/971,270

(22) Filed: Dec. 16, 2015

(51) Int. Cl. F03D 5/00; F03D 80/80; F03D 7/00; F03D 9/00

(52) U.S. Cl. CPC F03D 5/00; F03D 9/002; F03D 80/88; F03D 7/00; F05B 2220/706; F05B 2240/21; F05B 2240/12; F05B 2250/14; F05B 2250/11; F05B 2250/12

(57) ABSTRACT

A wind driven electricity generator may have a tower with a set of stationary airfoils mounted thereon. Each airfoil may have a slot on a low pressure side of the airfoil. Air flow may through the slot relative to an inside of the airfoil. Air flowing through the airfoil may flow through the tower. The air flowing through the tower may turn a rotor (or propeller). The rotor may turn an electrical generator to generate electricity. Each airfoil may have a slot on a high pressure side. Air flowing through the slot on the high pressure side may turn the rotor.

### BACKGROUND

Field

A wind driven electricity generator having airfoils that cause air to flow through a tower allowing a wind driven rotor and electrical generator turbine to be in a base adjacent to the ground.

Description of Related Art

A typical wind turbine that generates electricity has four main parts: a base, tower, nacelle and blades. The blades capture the wind energy, spinning a generator in the nacelle. The tower contains the electrical conduits, supports the nacelle, and provides access to the nacelle for maintenance.

An industrial wind turbine can include 116-ft blades at the top of a 212-ft tower for a total height of 328 feet. The nacelle can weigh more than 56 tons, the blade assembly can weigh more than 36 tons, and the tower itself can weigh about 71 tons for a total weight of 164 tons. As a result, the structure can be quite heavy and difficult to build.

The blades sweep a diameter of over 200 feet and the tip can travel at over 180 miles per hour. As a result the blades can be quite noisy and the blades are believed to kill or injure a significant number of birds.

At high wind speeds the blades must be feathered to prevent damage from over rotation.

What is needed is a wind driven electricity generator with no blades or nacelle at a top of the tower.

### SUMMARY

A wind driven electricity generator may have a tower with a set of stationary airfoils mounted thereon. Each airfoil may have a slot on a low pressure side of the airfoil. Air may flow through the slot relative to an inside of the airfoil. Air flowing through the airfoil may flow through the tower. The air flowing through the tower may turn a rotor that may be located near the ground. The rotor may turn an electrical generator to generate electricity.

### DRAWINGS

FIG. 1 shows airflow over an airfoil.

FIG. 2 shows air pressure around an airfoil.

FIG. 3 depicts air flowing out of a slot of opening in a top of the air foil.

FIG. 4 is a perspective view showing air flowing in an end of an airfoil and out the slot.

FIG. 5 shows a set of airfoils with wind flowing past the airfoils.

FIG. 6 shows opposed airfoils.

FIG. 7 depicts components of a tower structure.

FIG. 8 shows the tower components in more detail.

FIG. 9 depicts another embodiment of an airfoil set.

FIG. 10 shows a circular airfoil structure.

FIGS. 11-16 show alternate embodiments for airfoils sets.

FIG. 17 depicts embodiments that use both low and high pressure associated with an airfoil.

FIG. 18 shows the base depicted in FIG. 17 in more detail.

FIG. 19 shows an embodiment with slots oriented in a leading edge to trailing edge direction.

FIGS. 20 and 21 show an arrangement where the tower has an airfoil shape.

FIG. 22 shows a building airfoil.

FIG. 23 airfoil array with each airfoil having a to pivot shaft and a botom drive that rotates each airfoil individually.

FIG. 24 depicts an airfoil that can have it's shape changed.

FIG. 25 shows an airfoil with a symmetric shape.

FIG. 26 shows a building as an airfoil.

### DETAILED DESCRIPTION

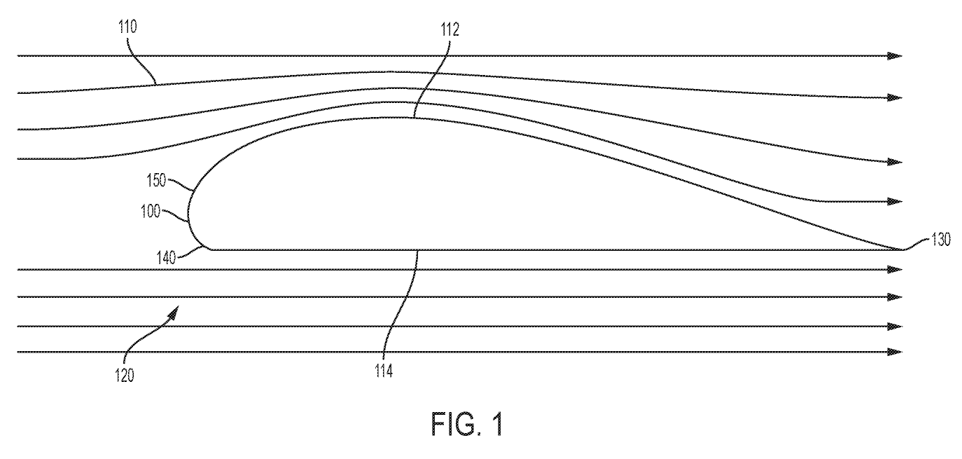

Flow of air/wind over an airfoil or wing 100, as shown in the side end view of FIG. 1, separates to pass around the airfoil 100. The air 110 flowing over a top of the airfoil conforms to the top of the airfoil 100 and must flow faster than the air 120 flowing past the bottom. The air 110 flowing faster over the top or camber side 112 creates a low pressure area above the airfoil that typically provides lift to the airfoil and the air 120 flowing along the bottom 114 of the airfoil 100 is at a higher pressure.

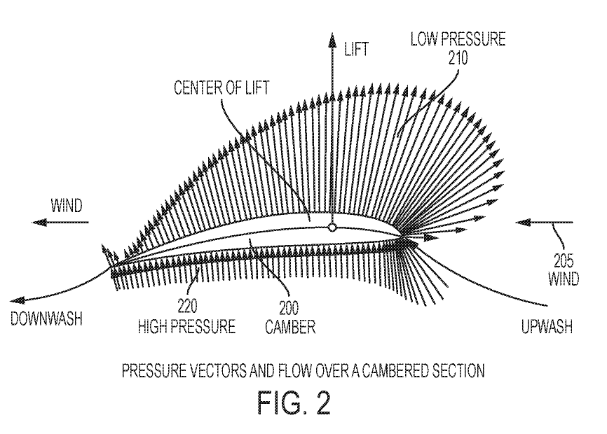

This difference in air pressure caused by the airflow 205 is depicted in side or end view FIG. 2 and shows the different air pressures (or an air pressure gradient) around an airfoil 200 by a length and direction of arrows. As can be seen, the low pressure in the area 210 varies dramatically along the top of the airfoil 200 and the high pressure is relatively constant in the high pressure area 220 along the bottom of the airfoil 200. The relative differences in air pressure effectively create a vacuum along the top of the wing that, as discussed previously, can produce a lifting force on the airfoil 200.

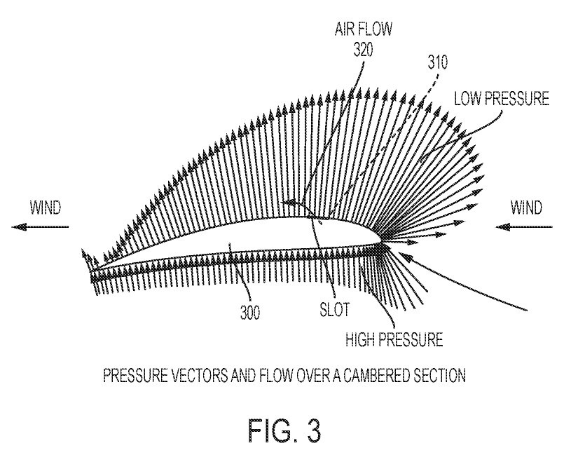

If a slot or opening 310 (see thicker portion of line) is created in the top of the airfoil 300, as depicted in end view FIG. 3, air 320 can be pulled or sucked out of the airfoil 300 by the reduced pressure or vacuum in the area on the top of the airfoil 300. When the wind is blowing along the airfoil 300 the air 320 from the slot or opening flows out toward the back or trailing edge. The slot is shown in FIG. 3 positioned somewhat toward the airfoil trailing edge and away from the lowest air pressure point indicated by the air pressure arrows for convenience of illustration but may preferably be positioned at the point of lowest air pressure point along the camber or curved upper surface of the airfoil 300. In this figure the slot may be moved more toward the leading edge of the airfoil 300.

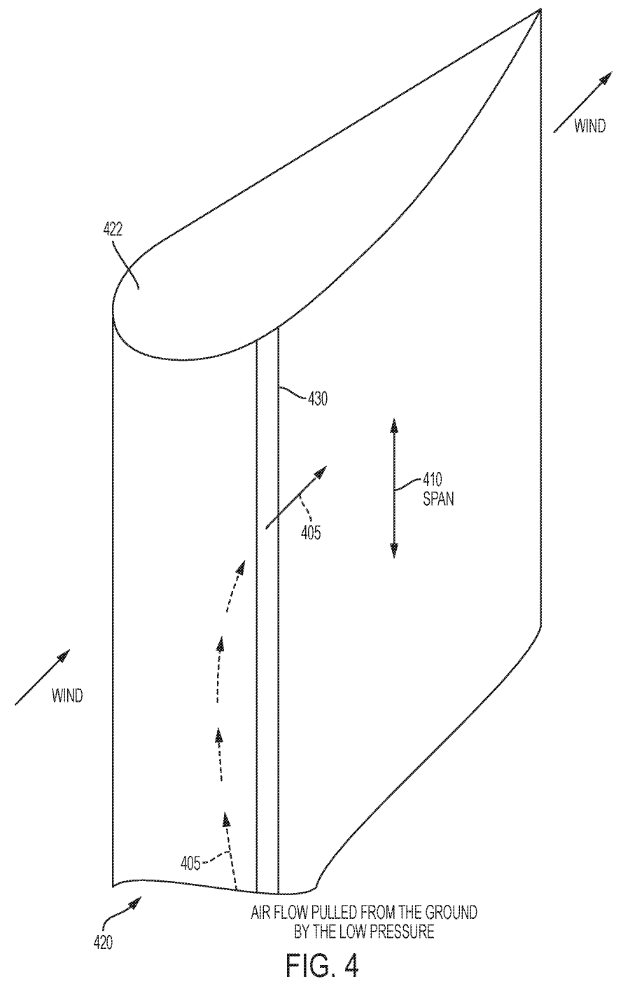

As shown in perspective view FIG. 4, air 405 can be allowed to enter the airfoil 400 along a length or span direction 410 of the airfoil 400 from an end 420, and that air 405 will flow out of the slot or opening 430. A top end 422 of the airfoil 400 is closed so that air flowing out of slot 430 flows into the airfoil 400 from the end or bottom opening 420.

The airfoil 400 is preferably constructed from a light weight, high strength, thin material, such as fiberglass, carbon fiber composite or even from a metal, such as titanium, aluminum or steel.

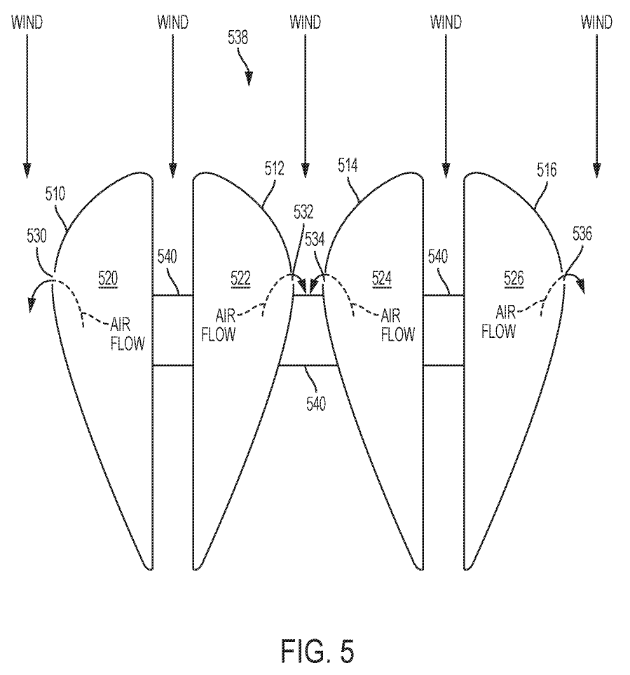

A top view of a set of stationary airfoils 510, 512, 514 and 516 in FIG. 5 shows air 520, 522, 524 and 526 being pulled up from the bottoms of the airfoils and out slots 530, 532, 534 and 536 by wind 538 passing over and between the airfoils. The air that enters at the ends of the airfoils may be pulled from an airway or duct 540.

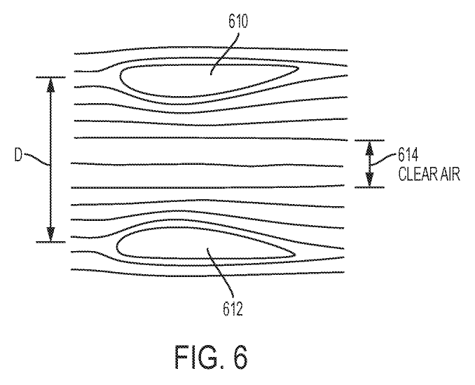

As can be seen by again reviewing FIG. 1, the airflow lines over the top of the airfoil 100 show that the air passing above the airfoil 100 is disturbed. That is, the air is not clear of disturbance. For the low pressure area to be efficiently created when two air foils have their low pressure sides confronting each other, such as airfoils 512 and 514 of FIG. 5, so that an efficient vacuum is created, the air between the airfoils needs to become undisturbed or “clean” or “clear” air or laminar flow. As a result, airfoils 610 and 612 that confront each other, as shown in top view FIG. 6, need to have the camber portion spaced apart a distance D that allows a region 614 of laminar flow to be produced. This distance may need to be about one chord or more depending on the velocity of the wind passing over the airfoils 610 and 612. A chord length is the distance between the trailing edge (see 130 of FIG. 1) and a point 140 on the leading edge 150 where the chord intersects the leading edge 150 of the airfoil. The airflow along the lower portion of the airfoil can also be disturbed as depicted in FIG. 6. However, the extent of the disturbance is much less and the airfoil spacing can be much closer.

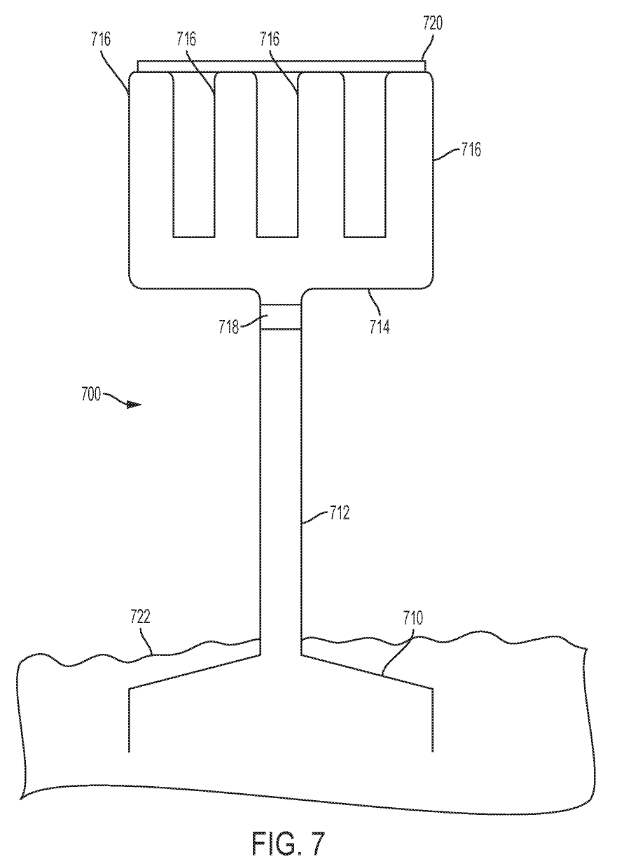

FIG. 7 is a side or profile view showing the major components of an airfoil wind tower. The structure 700 includes a base 710 that houses the turbine driven by airflow, the electric generator driven by the turbine, power switching equipment and control electronics. A tower support and air duct 712 rises from the base 710, it provides structural support and allows air to flow up from the base 710 toward a distribution duct 714. The distribution duct 714 distributes air from the tower support and air duct 712 toward the set of airfoils 716. Air flows or is pulled up from the base through the tower support and air duct 712, through the distribution duct 712 and toward the airfoils 716 where the air exits the airfoils 716 through slots, such as shown in prior figures. The wind that flows past the airfoils 716 in this view either flows toward the viewer when the leading edge of the airfoils 716 is away from the viewer, or the wind flows away from the viewer when the leading edge of the airfoils 716 is toward the viewer. A yaw drive 718 is used to keep the leading edges of the airfoils 716 facing into the wind. The yaw drive 18 is controlled by a wind vain (not shown) that determines the direction of the wind and signals the yaw drive as to when and which direction to rotate the set of airfoils 716. An airfoil brace 720 provides stabilization to the set of airfoils.

The tower 712 may preferably constructed from a material, such as steel, that can withstand high wind velocities that occur during a storm, although a composite material, such as light weight reinforced concrete, carbon fiber composite or fiberglass, may be used.

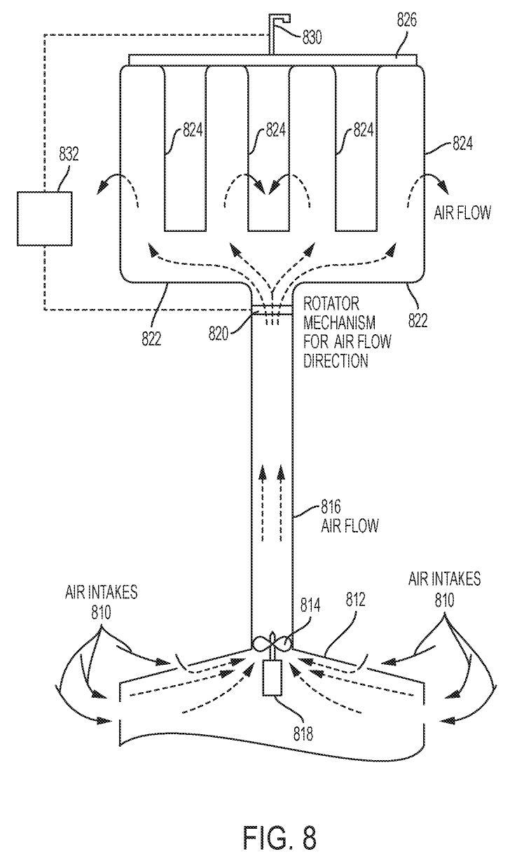

The airflow within the structure of FIG. 7 is depicted in more detail in FIG. 8 by air flow arrows. As can be seen, air flows in through air intakes 810 in the base 812 and turns a rotor blade 814 after or as it enters the tower support and air duct 816. The rotor blade 814, via a shaft, turns an electric turbine or generator 818. The air flows up the tower support and air duct 816, goes by or through the yaw drive section 820 and into the distribution duct 822. Air in the distribution duct 822 flows into the airfoils 824 and out of the slots (not shown) that extend for substantially the entire height of the airfoils. The airfoil brace 826 is connected to the airfoils 824. A wind vane 830 provides wind direction signals to a controller 832 that controls the yaw drive of the rotator 820.

Although FIGS. 7 and 8 each show four airfoils extending into the wind it is possible to have more or less airfoils. The figures also show the airfoils set on top of a tall tower. If the wind hugs the ground, such as in some mountain passes or as in the Great Plains, the set of airfoils can be much closer to if not directly at ground level. Because the rotor, generator, etc. may be located at ground level it is also possible to bury the base underground as shown by the ground level line 722 of FIG. 7

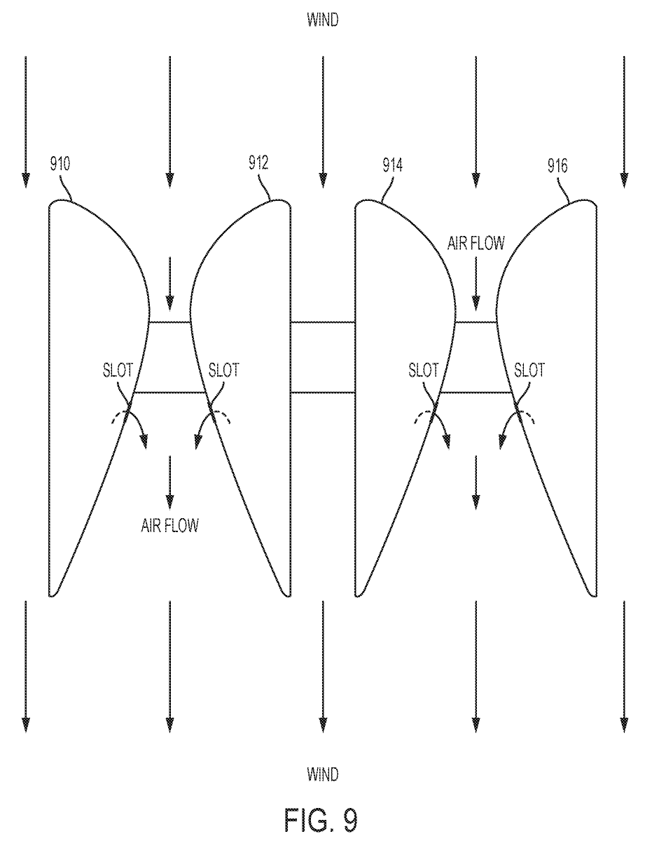

An alternate configuration of airfoils 910, 912, 914 and 916 viewed from a top of a support tower is shown in top view FIG. 9. This figure shows the camber sides of each pair of airfoils facing each other with the slots 920, 922, 924 and 926 through which air is pulled also facing each other.

The prior text discussed an airfoil system where the airfoils project up into the air. It is also possible to have other arrangements of adjacent airfoils, such as airfoils arranged like a bi-plane or tri-plane wing type wing arrangement. In such embodiments, a distribution duct would need to be provided on one or both ends of the airfoils set.

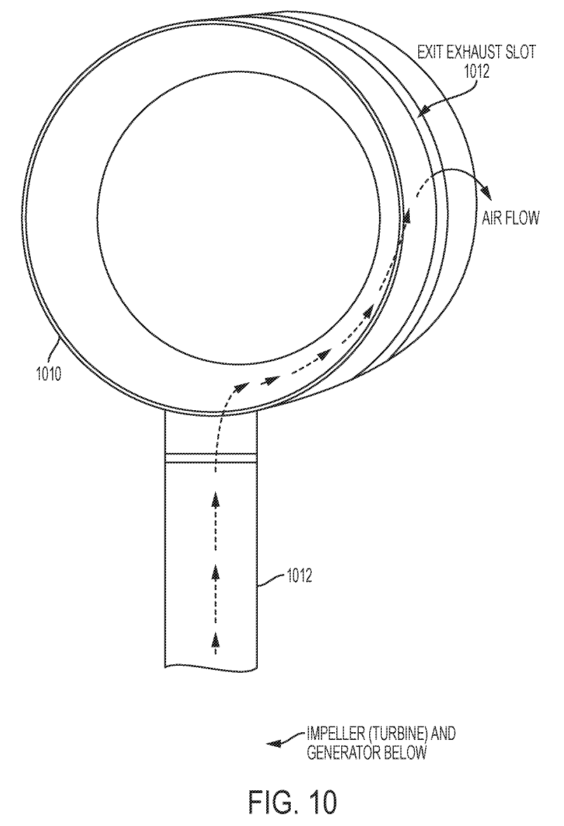

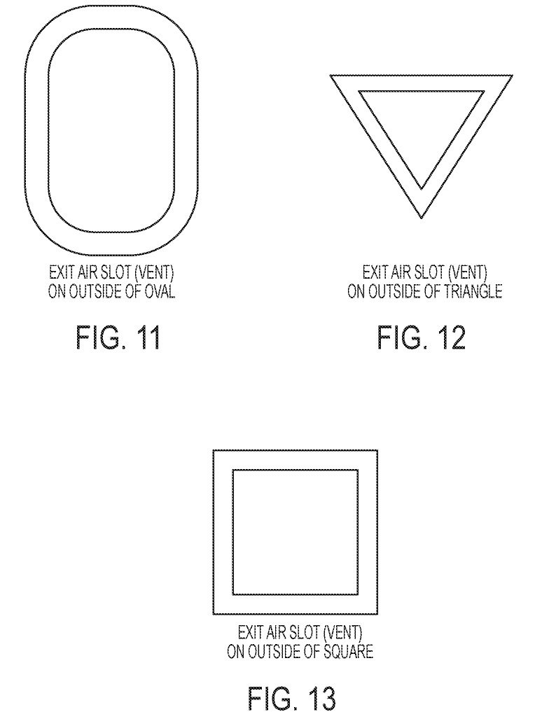

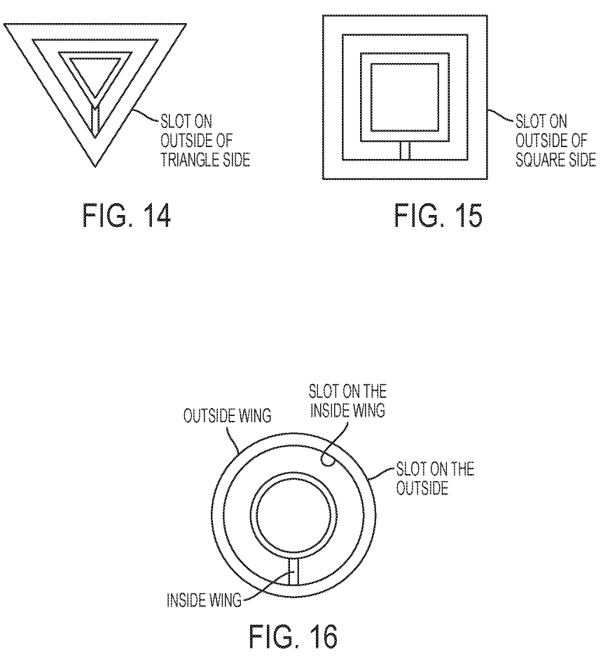

The airfoils also need not be linear. The perspective view of FIG. 10 shows a circular airfoil 1010 where air flows up through the tower structure 1012 and out a circular or circumferential slot 1012 on an outside of the airfoil 1010. The wind direction is into our and out of the page. FIGS. 11, 12 and 13 show oval, triangular and rectangular airfoil arrangements where the slot is on an outside of the airfoil set. FIGS. 14, 15 and 16 show concentric airfoil arrangements where the slot is on the outside of the outside airfoil and in the inside of the inside airfoil. Again air flow direction is into and out of the page.

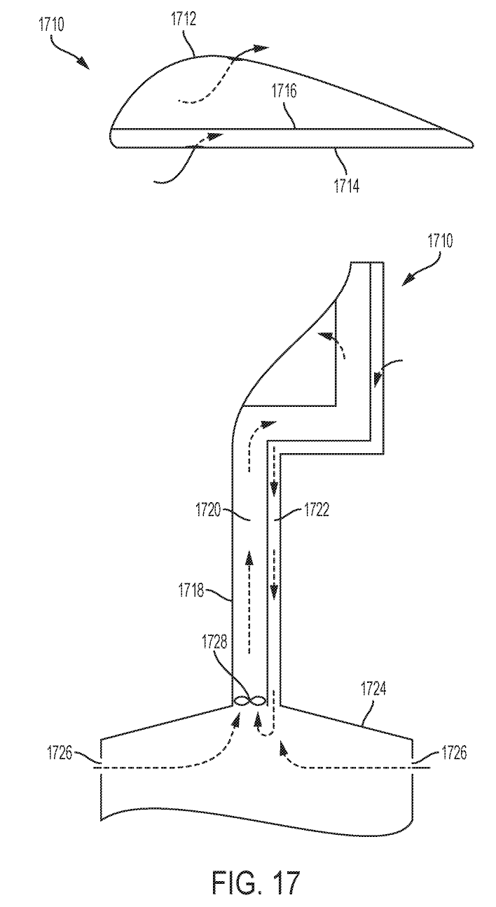

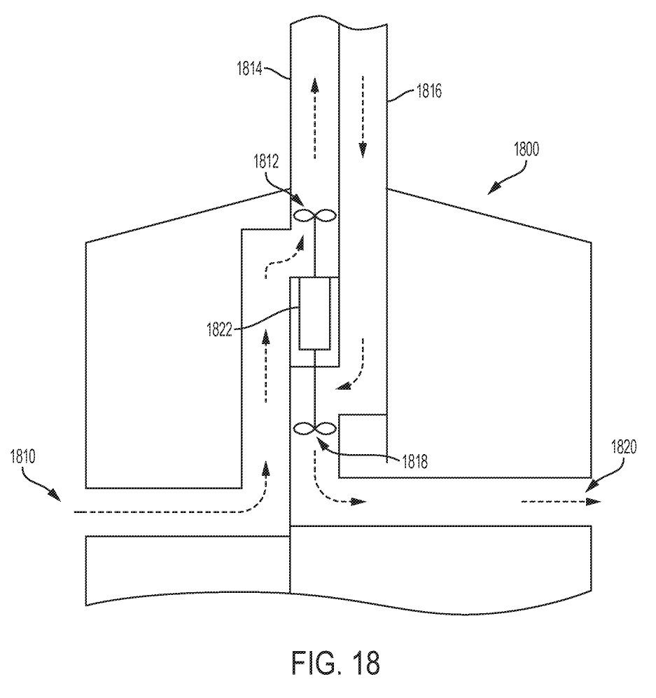

As discussed with respect to FIGS. 2 and 3 there is a relative low pressure side of an airfoil and a relative high pressure side. The prior embodiments discussed using the air pressure of the low pressure side. However, it is possible to take advantage of the low and high pressure sides of the airfoils to increase airflow past a turbine rotor. This is depicted in FIG. 17. Air from the low pressure side of the airfoil 1710 exits the low pressure side 1712 as shown. Air is also allowed to enter the airfoil 1710 on the high pressure side 1714. The airfoil 1710 includes an interior partition 1716 that divides air flowing through the airfoil 1710 in different directions. The tower 1718 include a duct 1720 for air flow up to the airfoil 1710 and a duct 1722 for air flowing from the airfoil 1710 downward toward the base 1724. In the base 1724, in addition to air flowing in from air intakes 1726 to the rotor 1728 and turning the rotor 1728, the duct 1722 feeds air toward the rotor toward the rotor 1728. The details of the base are shown in more detail in FIG. 18.

The base 1800 includes air entering intake 1810 and flowing by a first rotor 1812 up the tower in a first air passageway 1814 to the airfoils (not shown). Air flowing down a second air passageway 1816 of the tower from the airfoils flows by a second rotor 1818 and out an exhaust 1820 in the base 1800. The rotors 1812 and 1818 turn the electric generator 1822.

This embodiment increases the efficiency of the use of the airfoils.

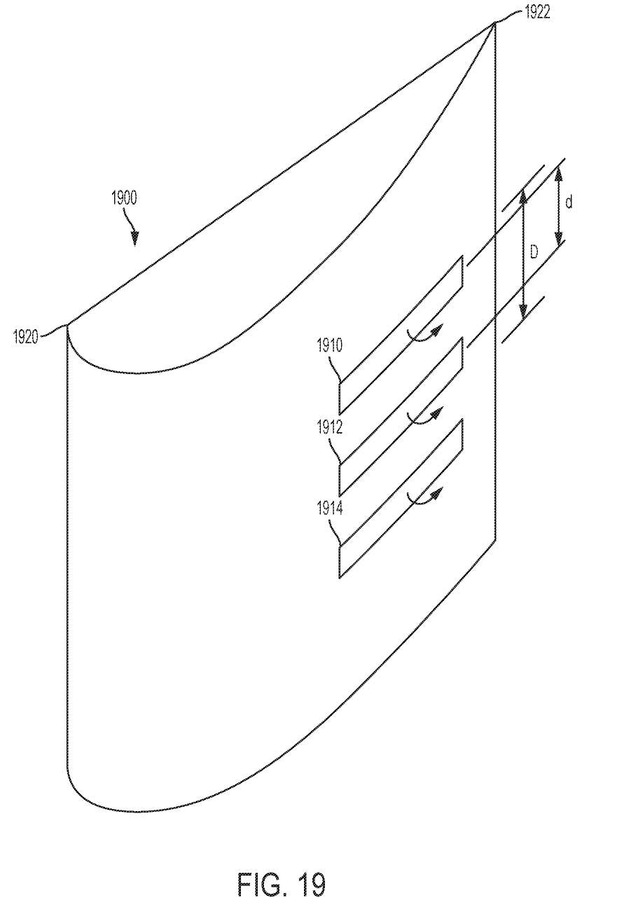

The long part on airfoil, for example, in a wing that reaches out from an airplane body to the wing tip, is typically called the span direction. As previously described, a slot in the camber side of the airfoil may be arranged or oriented in the span direction to essentially run a length of the airfoil. However, as depicted in FIG. 19, it possible to provide an airfoil 1900 with a series of slots 1910, 1912, 1914 that are on the low pressure side or camber side of the airfoil 1900, which run in a direction from the leading edge 1920 to the trailing edge 1922 (that is, perpendicular to the span direction). Air flows out of the slots 1910-1914 as wind passes by the airfoil 1900. The air flowing out of the slots turns the rotor of the electrical generator. Each pair of slots, such as slot pair 1910,1912, need to have the slots separated from each other in the span direction by a spacing that D would allow “clear” air d area to be maintained between the slots.

The air pressure differential on an airfoil is primarily the result of shape and its angle of attack. FIG. 1 shows an airfoil that may be an ultra light low wind velocity airfoil. The system discussed herein can include rotation mechanisms for each airfoil in a set that changes the angle of attack, and the rotation mechanism may also be used to change the angle of attack of the airfoils.

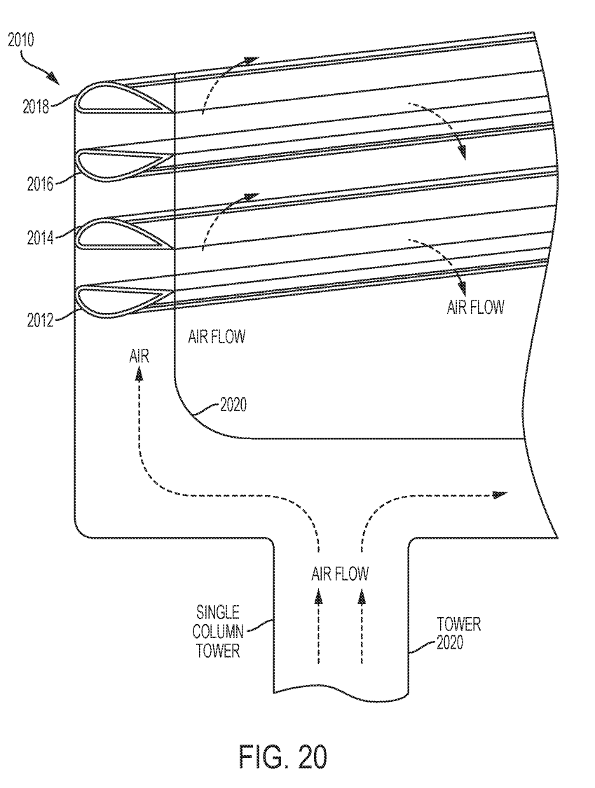

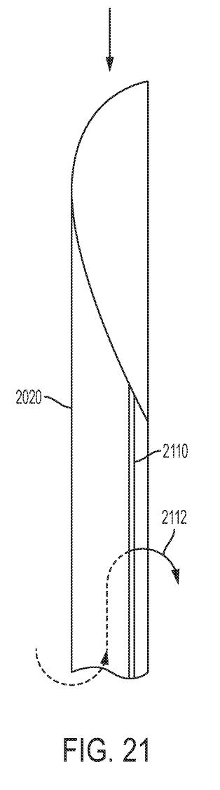

FIGS. 20 and 21 depicts a tower array of airfoils where not only are the horizontally arranged airfoils 2012-2018 arranged with a slot to draw air to drive the electric generator but the tower 2020 has a shape of an airfoil with a slot 2110 through which air 2112 is pulled to generate electricity.

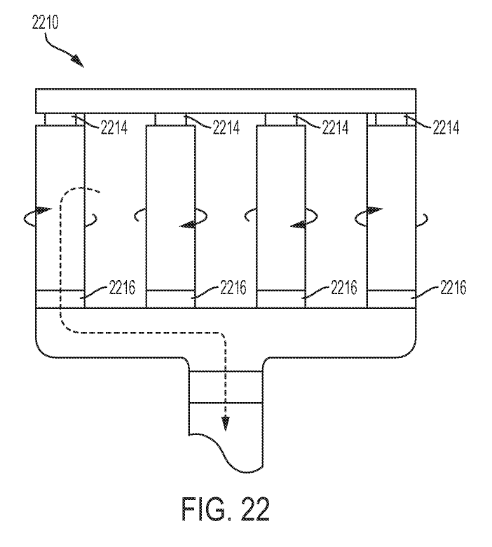

It is also possible in some circumstances for the wind to flow differently over each of the airfoils in an array, such as when the air velocity is high and the airfoils themselves create turbulence. In such a case, it may be appropriate to change an angle of attack of each airfoil to maximize the airflow used to generate electricity. FIG. 22 depicts an airfoil array 2210 having a pivot shaft 2214 at the top of each airfoil and a yaw drive 2216 that individually rotates each airfoil, such as airfoil 2214. This FIG. 22 shows the airfoil array with the “wings” arranged vertically. Of course, the airfoil array can be arranged horizontally or any specific optimal angle.

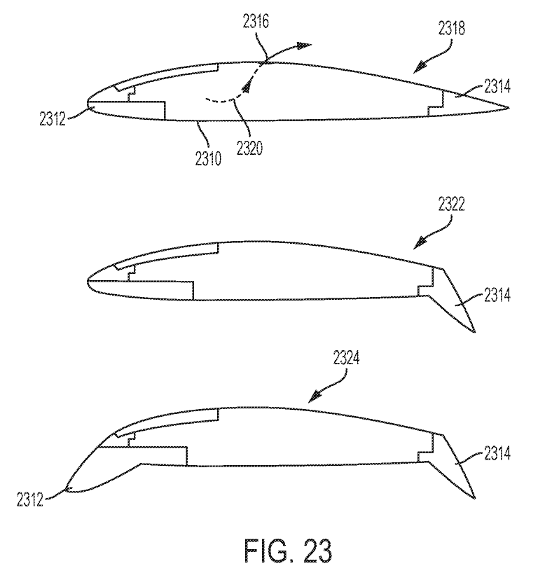

As wind velocity changes the lifting or vacuum efficiency of an airfoil changes. At higher wind velocity a high lift airfoil may create turbulence. To counteract such possible loss in efficiency the airfoil used in pulling air to generate electricity may have a shape that that may be controllably changed for optimal efficiency. FIG. 23 depicts an airfoil 2310 that can have it's shape changed. This airfoil may have a slat 2312 on the leading edge or may have a flap 2314 on a trailing edge or both as depicted in figure. The airfoil 2310 has an airflow slot 2316 along the top surface 2318 (into the page) allowing air 2320 to flow out and may also have a slot (not shown) along the bottom to allow in flow as discussed in previous embodiments. The slat and the flap allow the airfoil shape to be changed as wind speed changes. This is depicted by airfoil 2322 where the flap 2314 is extended and by airfoil 2324 where both the slat 2312 and flap 2314 are extended.

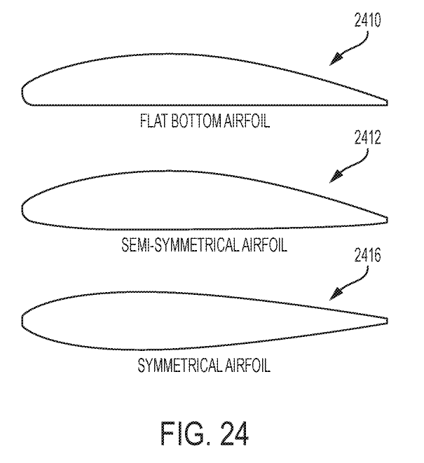

The airfoil of FIG. 1 is a non-symmetric airfoil. FIG. 24 depicts a flat bottom, non-symmetrical airfoil 2410, a semi-symmetrical airfoil 2412 and a symmetrical airfoil 2416.

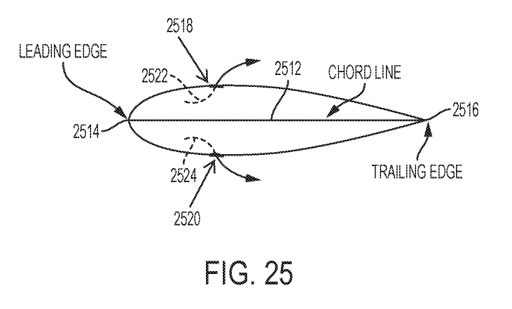

A symmetric airfoil 2510 as depicted in FIG. 25 is symmetrical around the chord line 2512 with the leading edge curved 2514 and the trailing edge 2516 pointed. Air flow slots 2518 and 2520 (into the page) allows air 2522 and 2524 to flow out of the airfoil in the low pressure areas.

The airfoil used in the system discussed herein may also be a Kline-Fogleman airfoil or KF airfoil. It is an airfoil design with single or multiple steps along the length or span of the airfoil.

The amount of air pressure change produced by an object by or past which wind is flowing depends on how much the flow is turned, which depends on the shape of the object. As a result, other shaped objects can be used to provide a relative pressure change that can be used to flow air past a rotor/generator.

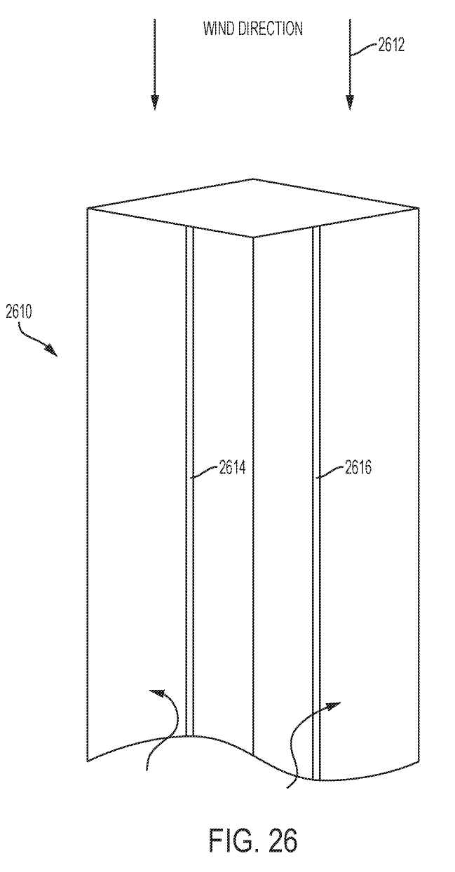

FIG. 26 depicts a vertical airfoil 2610 that has a rectangular cross section shape where the wind direction 2612 passes the structure and causes a low pressure area to be created on the side of the structure away from the wind or downwind of the structure. Slots 2614 and 2616 allow air to be pulled out of the structure and thereby drive an electric generator located at a lower level, such as ground level or below ground. The structure may be a very tall skyscraper type building where slots are arranged on each face of the building. The building may be able to supply some or all of the electricity needed by the building. Although a single slot is shown on each side of the building (2610) more than one slot may be used and the number of slots on each face may vary with height such that low elevation parts of the building have more or less slots than upper levels of the building. The shape of the building in cross section is shown as a rectangle (square in this case) but could be other shapes, such as triangular, pyramidal, truncated pyramid, round oval, etc.

The embodiments discussed herein provide a number of advantages over conventional industrial windmills. The rotor and generator may be located next to the ground or even underground allowing the structure to be lighter and use fewer materials. The noise from the system is thereby reduced. The visual impact of the structure is reduced. The adverse effects on birds and other species caused by contact with conventional rotating bladed wind structures are eliminated. Higher wind speeds can be used to generate electricity.

1. A wind driven electricity generator apparatus, comprising:
a set of stationary airfoils with each airfoil having a leading edge arranged to face into a wind and each airfoil having a slot arranged on a low pressure side of each airfoil through which air is pulled from inside the airfoil out through the slot, the airfoils each having an opening on a bottom and being closed on a top thereof;
a brace connecting the top of each of the airfoils;
an air duct connected to the airfoils through which air flows toward the airfoils;
a rotation mechanism connected to the air duct through which air flows toward the air duct and which rotates the air duct together with the set of airfoils to keep the leading edge facing into the wind and having a yaw drive;
a tower connected to the air duct via the rotation mechanism and through which air flows toward the air duct;
a rotor blade positioned to be turned by the air that flows through the tower;
an electrical generator connected to the rotor blade;
a base connected to the tower, the rotor blade and the generator and having air intakes through which air flows toward the rotor blade;
a wind vane sensing wind direction;
a controller connected to the wind vane and controlling the rotation mechanism responsive to wind direction; and
wherein at least two airfoils have the low pressure side facing each other and a spacing there between to create a clear air space there between, and
wherein the base may be underground.

2. An apparatus as recited in claim 1, wherein the airfoil comprises a first compartment associated with the low pressure side and a second compartment associated with a high pressure side into which air flows, the air duct comprises first and second ducts in airflow communication with the first and second compartments, respectively, the tower comprises first and second air passageways in airflow communication with the first and second ducts, and flowing into the second compartment flows to a second rotor blade connected to the electrical generator.

3. An apparatus as recited in claim 2, wherein air flows in the first air passageway toward the airfoil and flows in the second passageway away from the airfoil.

4. An apparatus as recited in claim 1, wherein an angle of attack of the airfoils is adjustable.

5. An apparatus as recited in claim 1, wherein each airfoil having a slot on high low pressure side of each airfoil through which air is pushed from outside the airfoil out through the slot into the tower to turn the rotor blade.

6. An apparatus, comprising:
an airfoil having an area with a relative air pressure difference associated therewith; and
an air mechanism to flow air relative to the air pressure difference relative to an inside the airfoil responsive to the low pressure.

7. An apparatus as recited in claim 6, further comprising an airflow slot in a low pressure side of the airfoil via which air flows out of the airfoil.

8. An apparatus as recited in claim 7, further comprising an electric generator driven by the air flowing out of the airfoil.

9. An apparatus as recited in claim 6, further comprising an airflow slot in a high pressure side of the airfoil via which air flows into the airfoil.

10. An apparatus as recited in claim 9, further comprising an electric generator driven by the air flowing into the airfoil.

11. An airfoil, comprising:
a bottom side; and
a top camber side creating a low pressure area when wind is passing by the airfoil and having a slot therein located in the low pressure area through which air is pulled from inside the airfoil by the low pressure.

12. An airfoil as recited in claim 11, wherein the slot is arranged in an airfoil span direction.

13. An airfoil as recited in claim 12, wherein the slot is arranged in a direction from a leading edge to a trailing edge.

14. An airfoil as recited in claim 13, further comprising a second slot arranged in the direction from the leading edge to the trailing edge.

15. A method, comprising:
providing an airfoil having an airflow slot in an airfoil low pressure side;
placing the airfoil slot in flowing air;
routing air flowing toward the slot from an inside of the airfoil by a rotor;
spinning the rotor via the airflow that flows toward the airfoil slot; and
rotating an electricity generator using the spinning rotor.

16. A method as recited in claim 15, further comprising routing high pressure air flow created by the airfoil by a second rotor coupled to the generator.

17. An apparatus, comprising:
a building with a vertical air flow slot running along a side of the building through which air flows;
a rotor blade inside the building positioned to be turned by the air that flows through the slot; and
an electrical generator connected to the rotor blade.
